(19) United States
(12) Patent Application Publication
(10) Pub. No.: US 2014/0376032 A1
(43) Pub. Date: Dec. 25, 2014

(54) PRINT SERVER, PRINT SYSTEM, AND PRINT METHOD

(71) Applicant: KYOCERA Document Solutions Inc., Osaka (JP)

(72) Inventor: Suguru Ishikawa, Osaka (JP)

(21) Appl. No.: 14/312,577

(22) Filed: Jun. 23, 2014

(30) Foreign Application Priority Data
Jun. 25, 2013 (JP) 2013-133043

(51) Int. Cl. G06F 3/12

(52) U.S. Cl. CPC G06F 3/1236; G06F 3/1294
USPC 358/1.14

(57) ABSTRACT

A print server includes a storage portion, a login control portion, an exclusive control portion, and a notification control portion. The storage portion is configured to store image data. The login control portion is configured to make a user be logged in in accordance with a login request from each of image forming apparatuses configured to form images based on the image data read from the storage portion. The exclusive control portion is configured to restrict execution of printing and deletion of the image data by a user whose login order is second or later among the users who have logged in. The notification control portion is configured to notify the user whose login order is second or later that printing and deletion of the image data are restricted.

### INCORPORATION BY REFERENCE

This application is based upon and claims the benefit of priority from the corresponding Japanese Patent Application No. 2013-133043 filed on Jun. 25, 2013, the entire contents of which are incorporated herein by reference.

### BACKGROUND

The present disclosure relates to a print system capable of reading out and printing image data stored in a print server by any image forming apparatus.

Generally, there is known a print system called a pull print system which can read out and print image data stored in a print server by any image forming apparatus. In addition, in this type of print system, whether or not a user has logged in to the print server on each image forming apparatus may be managed.

### SUMMARY

A print server according to one aspect of the present disclosure includes a storage portion, a login control portion, an exclusive control portion, and a notification control portion. The storage portion is configured to store image data. The login control portion is configured to make a user be logged in in accordance with a login request from each of image forming apparatuses configured to form images based on the image data read from the storage portion. The exclusive control portion is configured to restrict execution of printing and deletion of the image data by a user whose login order is second or later among the users who have logged in. The notification control portion is configured to notify the user whose login order is second or later that printing and deletion of the image data are restricted.

A print system according to another aspect of the present disclosure includes one or a plurality of print servers, a plurality of image forming apparatuses, a login control portion, an exclusive control portion, and a notification control portion. The print servers each have a storage portion configured to store image data. The image forming apparatuses are configured to form images based on the image data read from the storage portion. The login control portion is configured to make a user be logged in to each print server in accordance with a login request from each image forming apparatus to the print server. The exclusive control portion is configured to restrict execution of printing and deletion of the image data by user whose login order is second or later among the users who have logged in to the same print server. The notification control portion is configured to notify the user whose login order is second or later that printing and deletion of the image data are restricted.

A print method according to another aspect of the present disclosure includes a login control step, an exclusive control step, and a notification control step. In the login control step, a user is made to be logged in in accordance with a login request from each of image forming apparatuses configured to form images based on image data read from a storage portion configured to store the image data. In the exclusive control step, execution of printing and deletion of the image data by a user whose login order is second or later among the users who have logged in is restricted. In the notification control step, the user whose login order is second or later is notified that printing and deletion of the image data are restricted.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram showing the configuration of a print system according to an embodiment of the present disclosure.

FIG. 2 is a block diagram showing the hardware configuration of the print system according to the embodiment of the present disclosure.

FIG. 3 is a flowchart showing an example of a login control process executed by a print server according to the embodiment of the present disclosure.

FIG. 4 is a flowchart showing an example of an exclusive control process executed by the print server according to the embodiment of the present disclosure.

FIG. 5 is a sequence diagram for explaining an operation example of the print system according to the embodiment of the present disclosure.

FIG. 6 is a sequence diagram for explaining an operation example of the print system according to the embodiment of the present disclosure.

### DETAILED DESCRIPTION

Hereinafter, with reference to the accompanying drawings, an embodiment of the present disclosure will be described for understanding of the present disclosure. It is noted that the following embodiment is an example where the present disclosure is embodied, and therefore is not intended to limit the technical scope of the present disclosure.

[Print System 100]

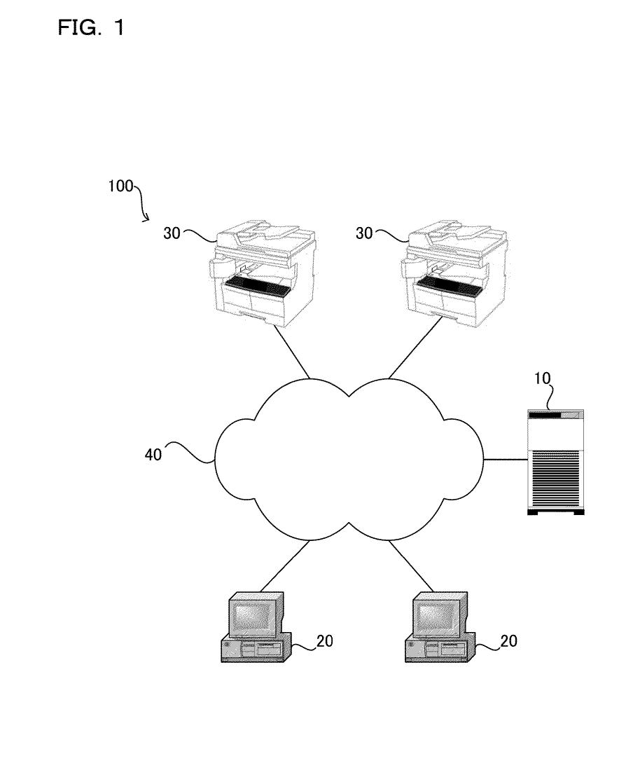

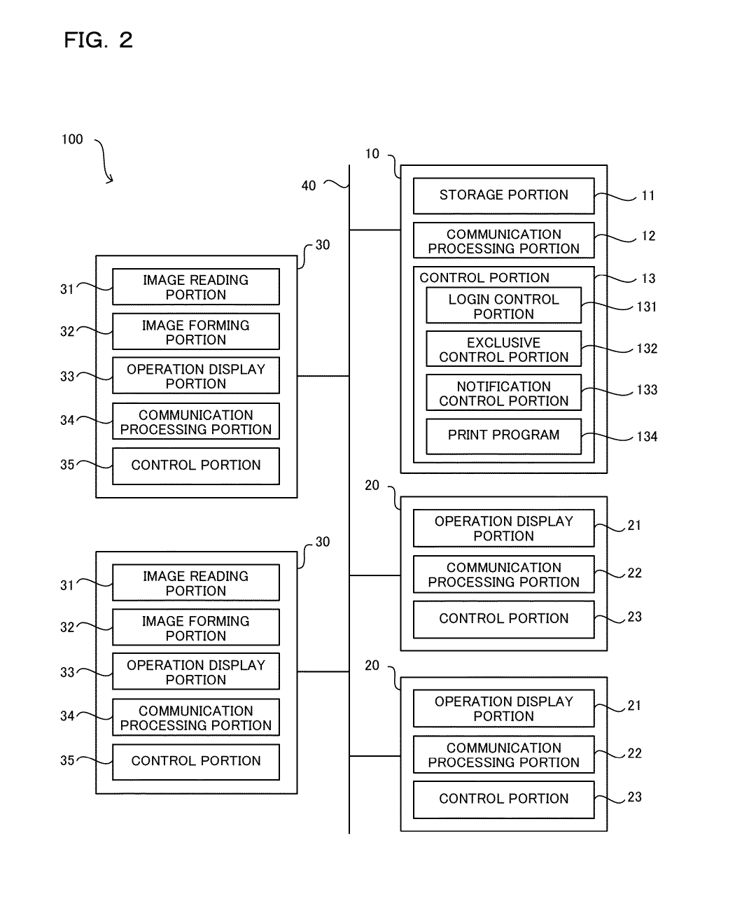

As shown in FIG. 1 and FIG. 2, a print system 100 according to the embodiment of the present disclosure includes one or a plurality of print servers 10, one or a plurality of information processing devices 20, and a plurality of image forming apparatuses 30. The print servers 10, the information processing devices 20, and the image forming apparatuses 30 are communicably connected via a network 40 such as the Internet or LAN. The print system 100 is a so-called pull print system that can read out and print, from each image forming apparatus 30, image data stored in advance in each print server 10 by each information processing device 20. It is noted that the image data is, for example, data for printing various documents such as a text, an image, or a picture by the image forming apparatus 30.

[Print Server 10]

As shown in FIG. 2, the print server 10 includes a storage portion 11, a communication processing portion 12, and a control portion 13. The storage portion 11 is a storage portion such as a hard disk or an SSD that stores the image data. The communication processing portion 12 has a communication interface that enables communication processing with the information processing device 20 and the image forming apparatus 30 via the network 40. In another embodiment, the information processing device 20 or the image forming apparatus 30 may also serve as the print server 10.

The control portion 13 includes a CPU, a RAM, a ROM, and an EEPROM. The CPU is a processor that executes various computing processes. The ROM is a nonvolatile storage portion storing in advance information such as a control program for causing the CPU to execute various processes. The RAM is a volatile storage portion, and the EEPROM is a nonvolatile storage portion. The RAM and the EEPROM are used as temporary storage memories (working areas) for various processes to be executed by the CPU. The control portion 13 executes, by using the CPU, various processes in accordance with the control program stored in the ROM, thereby performing overall control for the print server 10.

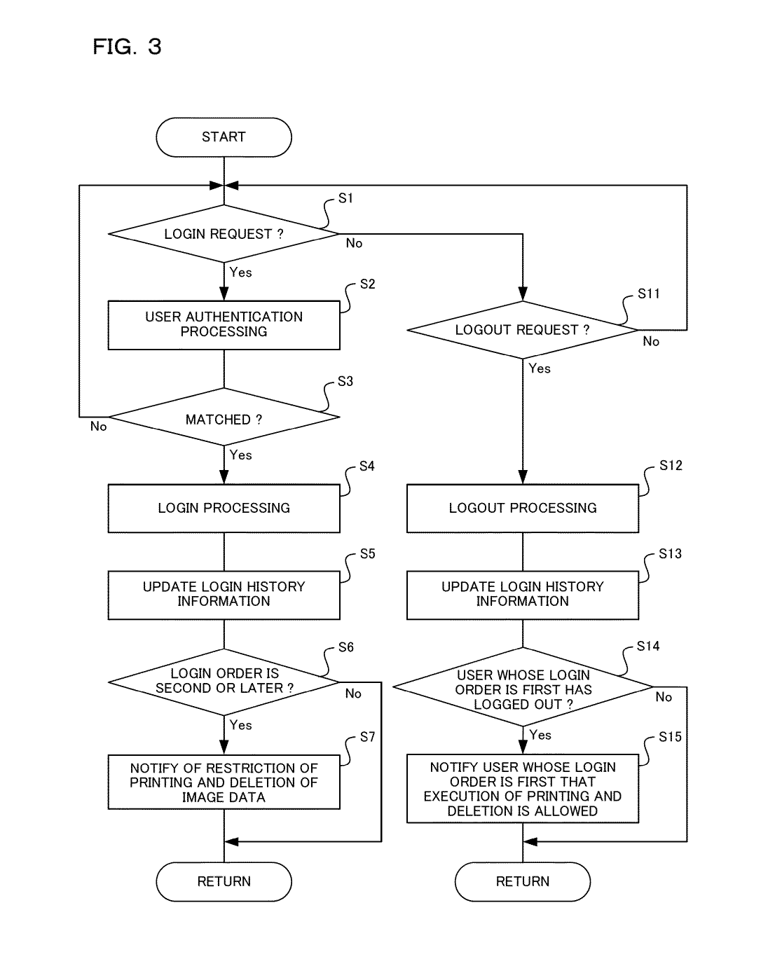

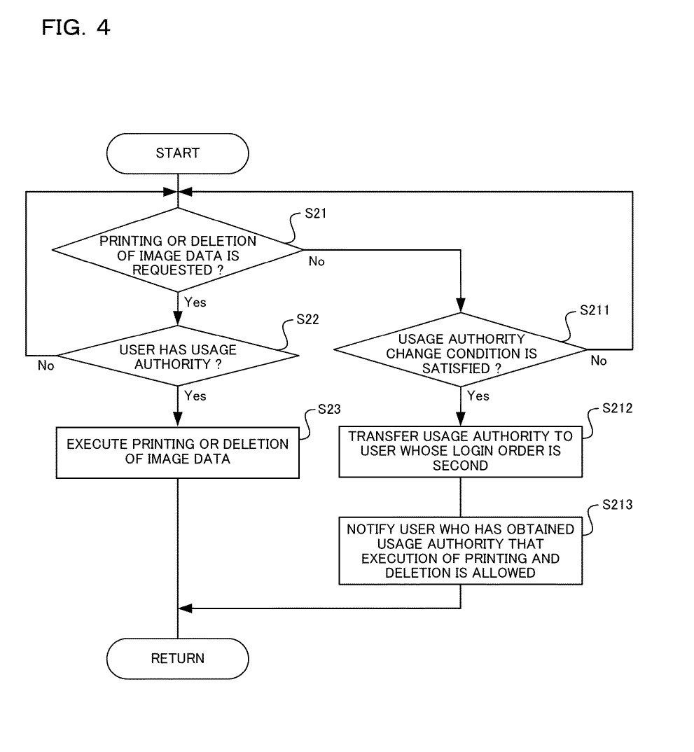

In addition, the control portion 13 includes a login control portion 131, an exclusive control portion 132, and a notification control portion 133. Specifically, the control portion 13 executes, by using the CPU, a print program 134 stored in the ROM, thereby functioning as the login control portion 131, the exclusive control portion 132, and the notification control portion 133. That is, the print program 134 is a print program for causing a computer such as the control portion 13 to execute each processing step in a login control process (see FIG. 3) and an exclusive control process (see FIG. 4) described later. The print program may be stored in a computer-readable storage medium such as a CD, a DVD, or a flash memory, and may be read from the storage medium by a reading device (not shown) of the print server 10 and installed into the print server 10. It is noted that the control portion 13 may be an electronic circuit such as ASIC or DSP. In this case, the login control portion 131, the exclusive control portion 132, and the notification control portion 133 are circuit modules included in the control portion 13.

In accordance with a login request from each image forming apparatus 30 which forms an image based on the image data read from the storage portion 11, the login control portion 131 makes a user of the image forming apparatus 30 be logged in to the print server 10. In addition, in accordance with a logout request from each image forming apparatus 30, the login control portion 131 makes the user be logged out of the print server 10.

The exclusive control portion 132 restricts execution of printing and deletion of the image data by users whose login orders are second or later among the users who have logged in. That is, the exclusive control portion 132 permits only the user whose login order is first among the users who have logged in, to execute printing and deletion of the image data.

The notification control portion 133 notifies the users whose login orders are second or later that printing and deletion of the image data are restricted. In addition, when the user whose login order is first has logged out, the notification control portion 133 notifies the next user whose login order becomes first that execution of printing and deletion of the image data is allowed.

[Information Processing Device 20]

As shown in FIG. 2, the information processing device 20 includes an operation display portion 21, a communication processing portion 22, and a control portion 23. The information processing device 20 is a personal computer, a tablet terminal, a smartphone, or a mobile phone, for example.

The operation display portion 21 includes a display portion and an operation portion. The display portion is a liquid crystal display or an organic EL display that displays various information in accordance with control instructions from the control portion 15. The operation portion is a touch panel, a keyboard, a mouse, or the like used for inputting various information to the control portion 15 in accordance with a user's operation.

The communication processing portion 22 has a communication interface that enables communication processing with the print server 10 and the image forming apparatus 30 via the network 40.

The control portion 23 includes a CPU, a RAM, a ROM, and an EEPROM. The CPU is a processor that executes various computing processes. The ROM is a nonvolatile storage portion storing in advance information such as a control program for causing the CPU to execute various processes. The RAM is a volatile storage portion, and the EEPROM is a nonvolatile storage portion. The RAM and the EEPROM are used as temporary storage memories (working areas) for various processes to be executed by the CPU. The control portion 23 executes, by using the CPU, various processes in accordance with various control programs stored in advance in the ROM, thereby performing overall control for the information processing device 20.

Specifically, in accordance with a user's operation on the operation display portion 21, the control portion 23 transmits the image data to be printed by the image forming apparatus 30, to the print server 10 via the communication processing portion 22. Thus, in the print server 10, the image data received from the image forming apparatus 30 is stored into the storage portion 11 by the control portion 13. It is noted that the transmission of the image data from the information processing device 20 to the print server 10 is performed after login to the print server 10 selected by the information processing device 20.

[Image Forming Apparatus 30]

As shown in FIG. 2, the image forming apparatus 30 includes an image reading portion 31, an image forming portion 32, an operation display portion 33, a communication processing portion 34, and a control portion 35. The image forming apparatus 30 is a multifunction peripheral having, besides a print function, a scan function, a copy function, and a FAX function. It is noted that the image forming apparatus 30 may be a printer with no image reading portion 31.

The image reading portion 31 has a light source that radiates light to a document, and a photoelectric conversion element that outputs an electric signal corresponding to the light reception amount of light reflected from the document, as image data of the document. The image data read by the image reading portion 31 is inputted to the image forming portion 32 or the communication processing portion 34.

The image forming portion 32 is an image forming portion of electrophotographic type or ink-jet type that executes an image forming process of forming an image on a sheet based on inputted image data. The image data is image data read by the image reading portion 31, image data read out from the print server 10, or image data inputted from the information processing device 20.

The operation display portion 33 includes a display portion such as a liquid crystal display that displays various information in accordance with control instructions from the control portion 35, and an input portion such as a touch panel used for inputting various information to the control portion 35 in accordance with a user's operation.

The communication processing portion 34 has a communication interface that enables communication processing with the print server 10 and the information processing device 20 via the network 40.

The control portion 35 includes a CPU, a ROM, a RAM, and an EEPROM. The CPU is a processor that executes various computing processes. The ROM is a nonvolatile storage portion storing in advance information such as a control program for causing the CPU to execute various processes. The RAM is a volatile storage portion, and the EEPROM is a nonvolatile storage portion. The RAM and the EEPROM are used as temporary storage memories (working areas) for various processes to be executed by the CPU. The control portion 35 executes, by using the CPU, various processes in accordance with various control programs stored in advance in the ROM, thereby performing overall control for the image forming apparatus 30.

For example, the control portion 35 executes a login request by transmitting, to the print server 10, a user ID and a password inputted by a user's operation on the operation display portion 33. It is noted that in the case where a plurality of print servers 10 are provided in the print system 100, the control portion 35 executes the login request to the print server 10 selected by a user's operation on the operation display portion 33. Then, in the print server 10, the user is authenticated and login is established, whereby access from the image forming apparatus 30 to the storage portion 11 of the print server 10 is allowed.

In addition, as an example of the login request, the image forming apparatus 30 may include a card reader that reads information from a magnetic card or an IC card, and may transmit, to the print server 10, user information read from an ID card that a user has by the card reader. Further, as an example of the login request, the image forming apparatus 30 may include a fingerprint authentication device that reads a fingerprint of a user, and may transmit, to the print server 10, information about a fingerprint read from a finger of the user by the fingerprint authentication device.

In the case where a plurality of users of the image forming apparatuses 30 have logged in to the same print server, the plurality of users may request printing or deletion of the same image data simultaneously or at slightly different timings. However, if the plurality of users have requested processing such as printing or deletion of the same image data, inconsistency occurs on the image data between the request timing and the execution timing. In this regard, the print system 100 prevents such inconsistency on image data due to requests for printing and deletion of the image data from a plurality of users of the image forming apparatuses 30 who have logged in to the same print server 10.

Specifically, in the print system 100, the login control process and the exclusive control process described later are executed by the control portion 13 of the print server 10. The present disclosure may be understood as a disclosure of a method for executing each processing step in the login control process and the exclusive control process by the print server 10. Further, the present disclosure may be understood as a disclosure of a computer-readable storage medium having stored therein the print program for causing the control portion 13 to execute each processing step in the login control process and the exclusive control process.

[Login Control Process]

First, with reference to a flowchart in FIG. 3, an example of steps in the login control process will be described. It is noted that S1, S2, . . . in FIG. 3 indicate numbers of processing steps executed by the control portion 13. Here, the login control process including steps S1 to S4 and S11 to S13 described later is executed by the login control portion 131 of the control portion 13. In addition, the notification control process including steps S6, S7 and S14 described later is executed by the notification control portion 133 of the control portion 13.

<Step S1>

In step S1, the control portion 13 determines whether or not the login request from the image forming apparatus 30 has been performed. Specifically, when login information such as a user ID and a password for logging in to the print server 10 has been received from the image forming apparatus 30, the control portion 13 determines that the login request has been performed.

Here, if the control portion 13 has determined that the login request has been performed (Yes in S1), the control portion 13 shifts the process to step S2. In addition, if the control portion 13 has determined that the login request has not been performed (No in S1), the control portion 13 shifts the process to step S11.

<Step S2>

In step S2, the control portion 13 executes authentication processing of checking a user who uses the image forming apparatus 30 in accordance with the login request. Specifically, the control portion 13 checks whether or not the login information received from the image forming apparatus 30 matches user's authentication information registered in advance.

<Step S3>

In step S3, the control portion 13 determines whether or not a check result of the authentication processing in step S2 indicates “match”. Here, if the control portion 13 has determined that the check result indicates “match” (Yes in S3), the control portion 13 shifts the process to step S4. On the other hand, if the control portion 13 has determined that the check result indicates “mismatch” (No in S3), the control portion 13 returns the process to step S1.

<Step S4>

In step S4, the control portion 13 executes login processing of making the user who uses the image forming apparatus 30 that has performed the login request, be logged in to the print server 10. Specifically, the control portion 13 notifies the image forming apparatus 30 that has performed the login request, that the login has been completed, and allows access from the image forming apparatus 30 to the storage portion 11. Thus, the user of the image forming apparatus 30 becomes able to refer to the image data stored in the storage portion 11.

<Step S5>

In step S5, the control portion 13 updates login history information which indicates the correspondence relationship between identification information and login orders of users who have logged in to the print server 10. Specifically, the control portion 13 adds the identification information and the login order of the user who has logged in in step S4, to the login history information. It is noted that the login history information is stored in the EEPROM of the control portion 13, for example. In addition, the login history information will be also updated in step S13 described later.

<Step S6>

In step S6, the control portion 13 determines whether or not the login order of the user who has logged in in step S4 is second or later. At this time, the control portion 13 can determine the login order of the user by referring to the login history information stored in the EEPROM.

Here, if the control portion 13 has determined that the login order is second or later (Yes in S6), the control portion 13 shifts the process to step S7. On the other hand, if the control portion 13 has determined that the login order is not second or later but first (No in S6), the control portion 13 returns the process to step S1.

<Step S7>

In step S7, the control portion 13 notifies the user who has logged in in step S4 that printing and deletion of the image data stored in the storage portion 11 are restricted. Specifically, the control portion 13 notifies the image forming apparatus 30 used by the user who has logged in in step S4, that printing and deletion of the image data stored in the storage portion 11 are restricted, and causes the operation display portion 33 to display that fact. Thus, the user who has logged in to the print server 10 can recognize that printing and deletion of the image data stored in the storage portion 11 of the print server 10 cannot be executed. Therefore, it is possible to prevent a plurality of users who have logged in to the same print server 10 from requesting printing and deletion of the same image data.

<Step S11>

On the other hand, if the control portion 13 has determined in step S1 that the login request has not been performed, in the subsequent step S11, the control portion 13 determines whether or not a logout request from the image forming apparatus 30 has been performed. Specifically, when a logout request signal transmitted from the image forming apparatus 30 in accordance with operation on the operation display portion 33 has been received, the control portion 13 determines that the logout request has been performed.

Here, if the control portion 13 has determined that the logout request has been performed (Yes in S11), the control portion 13 shifts the process to step S12. On the other hand, if the control portion 13 has determined that the logout request has not been performed (No in S11), the control portion 13 shifts the process to the step S1.

<Step S12>

In step S12, the control portion 13 executes logout processing of making the user who uses the image forming apparatus 30 that has performed the logout request, be logged out of the print server 10. Specifically, the control portion 13 notifies the image forming apparatus 30 that has performed the logout request, that the logout has been completed, and disables access from the image forming apparatus 30 to the storage portion 11. Thus, the user of the image forming apparatus 30 becomes unable to refer to the image data stored in the storage portion 11.

<Step S13>

In step S13, the control portion 13 updates the login history information. Specifically, the control portion 13 deletes, from the login history information, the identification information and the login order of the user who has logged out in step S12. Then, on the login history information, the control portion 13 advances the login orders of other users that are later than the login order of the user who has logged out in step S12.

<Step S14>

Then, in step S14, the control portion 13 determines whether or not a user whose login order is first has logged out. For example, when information about a user whose login order is first has been deleted on the login history information, the control portion 13 determines that the login order of the user who has logged out in step S12 has been first.

Here, if the control portion 13 has determined that the user whose login order is first has logged out (Yes in S14), the control portion 13 shifts the process to step S15. On the other hand, if the control portion 13 has determined that the user whose login order is first has not logged out (No in S14), the control portion 13 returns the process to the step S1.

<Step S15>

In step S15, after the user whose login order is first has logged out, the control portion 13 notifies the next user whose login order becomes first that execution of printing and deletion of the image data is allowed. Specifically, the control portion 13 notifies the image forming apparatus 30 used by the next user whose login order has become first, that execution of printing and deletion of the image data stored in the storage portion 11 is allowed, and causes the operation display portion 33 to display that fact. Thus, the user who has logged in to the print server 10 can recognize that execution of printing and deletion of the image data stored in the storage portion 11 of the print server 10 is allowed.

[Exclusive Control Process]

Next, with reference to a flowchart in FIG. 4, the exclusive control process will be described. It is noted that S21, S22, . . . in FIG. 4 indicate numbers of processing steps in the exclusive control process executed by the control portion 13. Here, the exclusive control process including steps S21 to S23, S211, and S212 described later is executed by the exclusive control portion 132 of the control portion 13. In addition, step S213 described later is executed by the notification control portion 133 of the control portion 13.

<Step S21>

In step S21, the control portion 13 determines whether or not printing or deletion of the image data stored in the storage portion 11 has been requested from the image forming apparatus 30. Here, if the control portion 13 has determined that printing or deletion of the image data has been requested (Yes in S21), the control portion 13 shifts the process to step S22. On the other hand, as long as printing or deletion of the image data has not been requested (No in S21), the control portion 13 causes the process to wait in step S21.

<Step S22>

In step S22, the control portion 13 determines whether or not the user of the image forming apparatus 30 who has requested printing or deletion of the image data has a usage authority. Specifically, based on the login history information, the control portion 13 determines only the user whose login order to the print server 10 is first, to be a user having the usage authority. That is, the control portion 13 determines a user whose login order to the print server 10 is second or later, not to have the usage authority.

Here, if the control portion 13 has determined that the user has the usage authority (Yes in S22), the control portion 13 shifts the process to step S23. On the other hand, if the control portion 13 has determined that the user does not have the usage authority (No in S22), the control portion 13 causes the image forming apparatus 30 to display the fact that the user does not have the usage authority, for example, and then returns the process to step S21. That is, in the print system 100, the user who does not have the usage authority is prohibited from requesting printing or deletion of the image data from the image forming apparatus 30 to the print server 10.

It is noted that the control portion 35 of each image forming apparatus 30 may prohibit request for printing or deletion of the image data until notification from the print server 10 in step S15 after notification from the print server 10 in step S7. In this case, request for printing or deletion of the image data from the image forming apparatus 30 to the print server 10 is not performed by a user who does not have the usage authority, and therefore step S22 can be omitted.

<Step S23>

In step S23, the control portion 13 executes printing or deletion of the image data, and returns the process to step S21. Thus, in the print system 100, even in the case where users of the plurality of image forming apparatuses 30 have logged in to the print server 10, printing or deletion of the image data only by the user whose login order is first and who has the usage authority is executed. That is, in the print system 100, in the case where a plurality of users of the image forming apparatuses 30 have logged in to the print server 10, printing or deletion of the image data by a user whose login order is second or later is restricted. Therefore, in the print system 100, inconsistency on image data due to requests for printing and deletion of the same image data from a plurality of users who have logged in to the same print server 10 is prevented.

<Step S211>

On the other hand, if it is determined in step S21 that printing or deletion of the image data has not been requested, in the subsequent step S211, the control portion 13 determines whether or not a predetermined usage authority change condition is satisfied. For example, the usage authority change condition is that a non-communication state (idle time) in which transmission or reception of data does not occur between the print server 10 and the image forming apparatus 30 used by the user whose login order is first continues for a predetermined time or longer. Alternatively, the usage authority change condition may be that communication abnormality occurs between the print server 10 and the image forming apparatus 30 used by the user whose login order is first.

Here, if the control portion 13 has determined that the usage authority change condition is satisfied (Yes in S211), the control portion 13 shifts the process to step S212. On the other hand, if the control portion 13 has determined that the usage authority change condition is not satisfied (No in S211), the control portion 13 returns the process to step 51.

<Step S212>

In step S212, the control portion 13 transfers the usage authority to the user whose login order is second, based on the login history information. Specifically, the control portion 13 restricts printing and deletion of the image data by the user whose login order is first, and allows the user whose login order is second, to execute printing and deletion of the image data. Therefore, in the print system 100, the print server 10 is prevented from being unnecessarily occupied for a long time by one image forming apparatus 30. It is noted that information about presence and absence of the usage authority is stored in the login history information, for example.

<Step S213>

In step S213, the control portion 13 notifies the user who has obtained the usage authority in step S212, that execution of printing and deletion of the image data is allowed. Specifically, the control portion 13 notifies the image forming apparatus 30 used by the user who has obtained the usage authority, that execution of printing and deletion of the image data stored in the storage portion 11 is allowed, and causes the operation display portion 33 to display that fact. Thus, a user who has logged in to the print server 10 can recognize that execution of printing and deletion of the image data stored in the storage portion 11 of the print server 10 is allowed. In addition, if communication processing can be performed between the print server 10 and the image forming apparatus 30 that has lost the usage authority in step S213, the control portion 13 may notify the image forming apparatus 30 that has lost the usage authority, of that fact, in step S213.

In another embodiment, in steps S11 and S12 in the login control process, the control portion 13 may execute automatic logout if a non-communication state between the print server 10 and the image forming apparatus 30 whose login order is first continues for a predetermined time or longer. In addition, in steps S11 and S12 in the login control process, the control portion 13 may also execute automatic logout if communication abnormality has occurred between the print server 10 and the image forming apparatus 30 whose login order is first. Also in this case, the print server 10 is prevented from being unnecessarily occupied for a long time by one image forming apparatus 30.

As described above, the print system 100 permits, among a plurality of users of the image forming apparatuses 30 who have logged in to the same print server 10, only a user of one image forming apparatus 30 to request printing and deletion of the image data. Therefore, inconsistency on image data due to requests for printing and deletion of the image data from a plurality of users of the image forming apparatuses 30 who have logged in to the same print server 10 is prevented.

[Operation Examples of Print System 100]

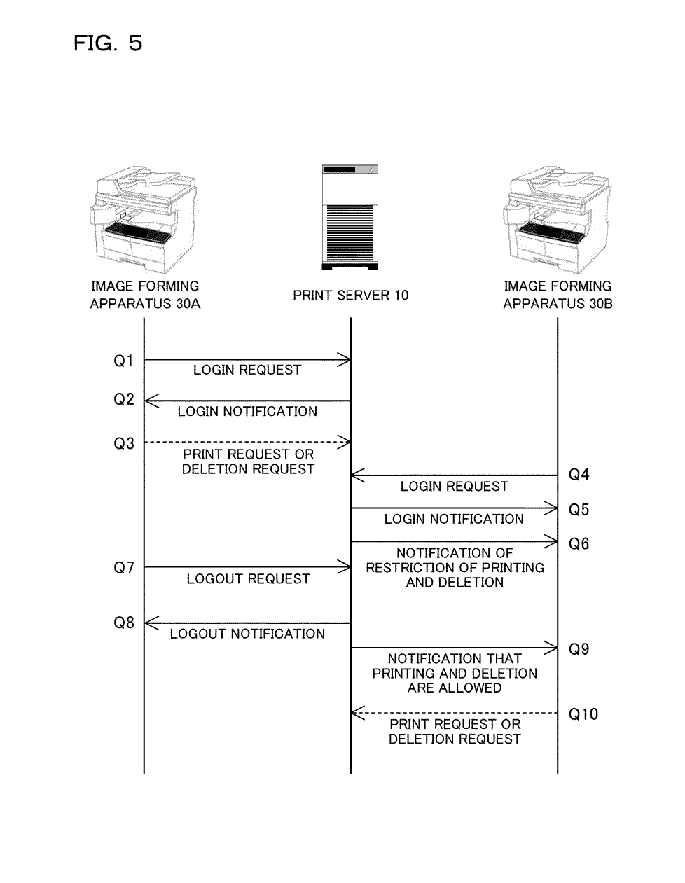

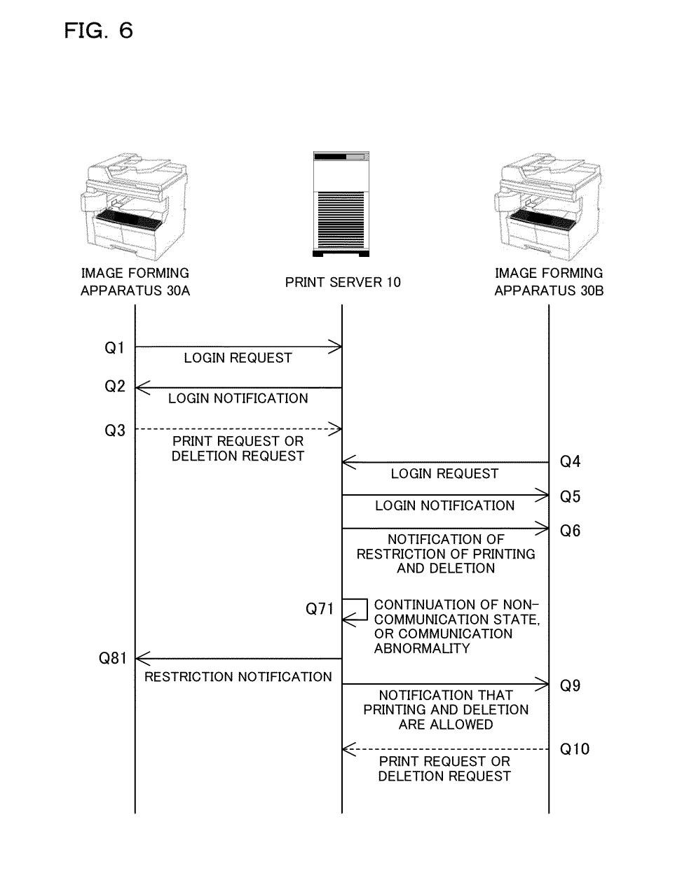

Hereinafter, with reference to FIG. 5 and FIG. 6, operation examples of the print system 100 will be described. It is noted that Q1, Q2, . . . in FIG. 5 and FIG. 6 indicate numbers of steps in the operations of the print system 100. Here, two image forming apparatuses 30 provided in the print system 100 are referred to as an image forming apparatus 30A and an image forming apparatus 30B. It is noted that in FIG. 6, the same steps as in the operation shown FIG. 5 are denoted by the same reference characters, and the description thereof is omitted.

First, as shown in FIG. 5, when the image forming apparatus 30A performs a login request (step Q1) and the print server 10 performs login authentication correctly, the print server 10 transmits a login notification to the image forming apparatus 30A (step Q2). At this time, the other image forming apparatus 30 has not logged in to the print server 10. Therefore, on the image forming apparatus 30A, besides reference to the image data stored in the storage portion 11 of the print server 10, request for printing and deletion of the image data can be performed (step Q3).

Thereafter, when the image forming apparatus 30B performs a login request (step Q4) and the print server 10 performs login authentication correctly, the print server 10 transmits a login notification to the image forming apparatus 30B (step Q5). In addition, the print server 10 notifies the image forming apparatus 30B that printing and deletion of the image data stored in the storage portion 11 are restricted (step Q6). It is noted that, at this time, the image forming apparatus 30B can refer to the image data stored in the storage portion 11.

Next, when the image forming apparatus 30A performs a logout request (step Q7), the print server 10 executes logout processing for the image forming apparatus 30A and transmits a logout notification to the image forming apparatus 30A (step Q8). Then, the print server 10 gives a usage authority for printing and deletion of the image data to the image forming apparatus 30B which has logged in second, and notifies the image forming apparatus 30B that printing and deletion of the image data are allowed (step Q9). As a result, on the image forming apparatus 30B, besides reference to the image data stored in the storage portion 11 of the print server 10, request for printing and deletion of the image data can be performed (step Q10).

As shown in FIG. 6, even in the case where the image forming apparatus 30A does not perform a logout request, if a non-communication state between the image forming apparatus 30A and the print server 10 continues or communication abnormality has occurred therebetween (step Q71), printing and deletion of the image data by the image forming apparatus 30A are restricted and the image forming apparatus 30A is notified of that fact (step Q81). Then, printing and deletion of the image data by the image forming apparatus 30B are allowed, and the image forming apparatus 30B is notified of that fact (step Q9).

It is to be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A print server comprising:
a storage portion configured to store image data;
a login control portion configured to make a user be logged in in accordance with a login request from each of image forming apparatuses configured to form images based on the image data read from the storage portion;
an exclusive control portion configured to restrict execution of printing and deletion of the image data by a user whose login order is second or later among the users who have logged in; and
a notification control portion configured to notify the user whose login order is second or later that printing and deletion of the image data are restricted.

2. The print server according to claim 1, wherein if the user whose login order is first has logged out, the notification control portion notifies the next user whose login order becomes first that execution of printing and deletion of the image data is allowed.

3. The print server according to claim 1, wherein if a non-communication state with the image forming apparatus used by the user whose login order is first continues for a predetermined time or longer or communication abnormality with the image forming apparatus has occurred, the exclusive control portion restricts execution of printing and deletion of the image data by the user whose login order is first, and allows execution of printing and deletion of the image data by the user whose login order is second.

4. The print server according to claim 3, wherein the notification control portion notifies the user allowed to execute printing and deletion of the image data, that execution of printing and deletion of the image data is allowed.

5. A print system comprising:
one or a plurality of print servers each having a storage portion configured to store image data;
a plurality of image forming apparatuses configured to form images based on the image data read from the storage portion;
a login control portion configured to make a user be logged in to each print server in accordance with a login request from each image forming apparatus to the print server;
an exclusive control portion configured to restrict execution of printing and deletion of the image data by a user whose login order is second or later among the users who have logged in to the same print server; and
a notification control portion configured to notify the user whose login order is second or later that printing and deletion of the image data are restricted.

6. The print system according to claim 5, wherein each print server includes the login control portion, the exclusive control portion, and the notification control portion.

7. A print method comprising:
a login control step of making a user be logged in in accordance with a login request from each of image forming apparatuses configured to form images based on image data read from a storage portion configured to store the image data;
an exclusive control step of restricting execution of printing and deletion of the image data by a user whose login order is second or later among the users who have logged in; and
a notification control step of notifying the user whose login order is second or later that printing and deletion of the image data are restricted.
